(19) United States
(12) Patent Application Publication
(10) Pub. No.: US 2007/0237106 A1
(43) Pub. Date: Oct. 11, 2007

(54) SYSTEMS AND METHODS FOR DELIVERING CONTENTS USING BROADCAST NETWORKS

(76) Inventors: Vaibhav Rajan, Bangalore (IN); Ajay Gupta, Bangalore (IN); Chandrasekar Venkatraman, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/692,209

(22) Filed: Mar. 28, 2007

Related U.S. Application Data
(63) Continuation of application No. PCT/IN05/00269, filed on Aug. 10, 2005.

(51) Int. Cl. H04J 3/08

(52) U.S. Cl. 370/315

(57) ABSTRACT

Systems and methods for delivering program related contents to electronic devices using existing broadcast networks. The methods include receiving a program signal of a program content and supplementary content which is associated thereto, combining the supplementary content with the program signal to form a data-augmented signal which is subsequently modulated with a carrier signal for broadcasting to conventional broadcast receivers. At the receiver, the supplementary content is recovered and delivered to the electronic devices at substantially the same time as the program content is rendered at the receivers.

### FIELD OF INVENTION

The present invention relates to systems and methods for delivering electronic data. More specifically, it relates to systems and methods for delivering contents to electronic devices using broadcast networks such as television and radio broadcasts.

### BACKGROUND

Nowadays, portable electronic devices such as mobile phones, personal digital assistances (PDA), and laptop PCs are used widely. Typically, users of these devices want to personalize their devices with their favorite ring-tones and screen-savers. They also want to playback songs and video clips and play games on their devices. However, content creators and application developers for these devices need a cost effective and wide reaching distribution channel through which they can reach their customers.

Currently, the foregoing contents are typically distributed using portable storage media such as CD, DVD, and the like portable data storage means. With the pervasive availability of wireless communications, content can also be delivered through telecommunication infrastructures via a telecom service provider or through a portal on the Internet.

For example, the telecom service provider provides codes corresponding to different ring-tones. To download a ring-tone, a user has to send an SMS indicating a code corresponding to a ring-tone to a particular number provided by the telecom service provider. Upon receiving the request and verification, the desired ring-tone is then sent to the mobile phone of the user as an EMS and thereafter the ring-tone is installed on the mobile phone. Typically, this is a premium messaging service provided by most telecom service providers and users have to pay extra charges for this service. Apart from the high cost, users are inconvenienced with the problem of having to remember the codes corresponding to the desired ring-tones as well as the requesting numbers to which the users need to send ring-tone requests.

Another example of delivering ring-tones to users is using the Internet. There are numerous portals where ring-tones as well as other contents for mobile phones are available. To obtain a ring-tone, a user has to logon to the Internet using a PC, visit a relevant portal and download the ring-tone to the PC and thereafter downloading the ring-tone to the mobile phone using either a wired or wireless connection (e.g. Infra-Red, WiFi, or Bluetooth). The entire process is time consuming and cumbersome for the average users.

In the case where the mobile phone is WAP enabled, the user can use the mobile phone to browse the Internet portal and download the ring-tone directly to the mobile phone. However, WAP connections are typically slow and generally not favored by users. Furthermore, the small form factor of most mobile phones does not facilitate easy Internet browsing and searching. Therefore, it is desirous to provide an alternative distribution channel that alleviates at least some of the foregoing limitations.

### BRIEF DESCRIPTION OF THE DRAWINGS

Embodiments of the present invention are herein described, purely by way of example, with reference to the accompanying drawings, in which:

FIG. 1A illustrates the location of a vertical blanking interval in a conventional broadcast television signal employed in an embodiment of the present invention;

FIG. 1B illustrates the location of a horizontal blanking interval in a conventional broadcast television signal employable in an embodiment of the present invention;

FIG. 2A illustrates a system for providing a data-augmented AV signal in accordance with an embodiment of the present invention;

FIG. 2B illustrates a method of providing a data-augmented AV signal in accordance with an embodiment of the present invention;

FIG. 3A illustrates a system for processing a data-augmented AV signal in accordance with an embodiment of the present invention.

FIG. 3B illustrates a method of processing a data-augmented AV signal in accordance with an embodiment of the present invention.

FIG. 3C illustrates a radio system for processing a radio data-augmented signal in accordance with an embodiment of the present invention.

FIG. 4 illustrates a functional block diagram of a supplementary content processor shown in FIG. 3A in accordance with an embodiment of the present invention;

FIG. 5A illustrates a system for delivering contents in accordance with an embodiment of the present invention; and

FIG. 5B illustrates a method of delivering contents in accordance with an embodiment of the present invention.

### DETAILED DESCRIPTION

Television and radio broadcast technologies are mostly used for delivering program contents such as news, sports, movies, and the like entertaining and informing programs to audience members (i.e. viewers and listeners) on a mass scale. Businesses are also heavily relying upon television and radio broadcasts to advertise their products. Government entities also use television and radio broadcasts to reach as many people as possible in conveying information or warning of an impending dangerous situation.

Given the wide reaching effect of such broadcasts, it is desirable to be able to also deliver supplementary content, such as mobile phone ring-tones, games, music, video clips, images, text data, and the like contents, along with the broadcasting programs. Accordingly, systems and methods for delivering contents to electronic devices using the television or radio broadcast technologies are described hereinafter with reference to the accompanying drawings. The systems and methods enable contents to be delivered to wide audiences of television or radio programs using existing television or radio broadcasting networks.

For clarity and convenience, the following definitions are used herein: The term “data-augmented AV signal” refers to an AV signal of a television program content or an audio signal of a radio program content (hereinafter generally referred to as AV signal) which has “supplementary content” added to the AV signal. The data-augmented AV signal has the format of the original television or radio AV signal. Typically, the supplementary content is inserted into “a non-program portion” of the AV signal while the program content is carried in a program portion of the AV signal.

The term “supplementary content” refers to information or data relating to the program content of the AV signal of a television or radio broadcast program. The information or data can be, for example, mobile phone ring-tones, music, games, pictures, video clips, sound bites, general information, and the like audience desired information all of which are associated with the program content. The supplementary content is able to be printed on a printer, reproduced or rendered on an electronic device, or stored in a data storage device, in an embodiment, substantially concurrently with the rendering of the program content.

The description “non-program portion” refers to the portion of the AV signal which is reserved for conveying information or data other than the program content. Exemplary embodiments of the non-program portion of the AV signal include the vertical blanking interval (VBI) of an analog television signal or an equivalent signal portion of digital television broadcast signal (referred to as DVB-VBI and DVB-TXT in the Digital Video Broadcast (DVB) Standard), as well as equivalents in digital radio broadcasting (e.g. the programming associated data channel in a digital audio broadcast signal).

The term “conventional broadcast receiver” refers to radio and television receivers or sets which are primarily dedicated to the function of receiving radio and/or television broadcasts, respectively. The conventional broadcast receiver typically has a demodulation circuit operable to extract program content from the data-augmented AV signal which has the same format as the conventional AV signal.

“Conventional radio receivers” within this definition include digital audio radios as described below. Other digital and analog receivers operable to extract program content from a radio broadcast signal may be employed in alternative embodiments. As used herein, the term “conventional television set” refers to conventional analog television sets, such as those configured to process television broadcast signals transmitted in NTSC format, using, for example, North American Basic Teletext (NABTS), PAL and SECAM broadcast formats, using, for example, the European Broadcast Union (EBU) Teletext Standards. In a further embodiment, the term “conventional television set” includes digital televisions receivers, such those operable to process HDTV broadcasts using, for example, the Vertical Ancillary DATA (VANC), and the like standards. Notwithstanding specific references made herein, the term “conventional television set” extends to television sets primarily operable to receive and process broadcast signals, regardless of when it is developed, which employ a non-program portion of the AV signal onto which the supplementary content can be inserted. Specifically excluded from “conventional broadcast receivers” are systems, such as computers, which can be programmed or otherwise modified to emulate the functionality of a commonly known television or radio receiver. Such systems do not have as its primary function to receive and process such broadcast signals, and are not specifically dedicated to operate as broadcast receivers, and accordingly are not within the scope of the present disclosure.

The term “conventional” as used with regard to broadcast, radio, or television receivers/sets refers to the primary functionality of the broadcast receiving system as described, and does not refer to the timing of when such a broadcast system was developed or deployed, which may be at any time during the past, present or future.

Television Data-Augmented AV Signal

As known in the art of analog television broadcasting, program content of a television program is provided in the form of an AV signal which includes a program portion and non-program portion in each frame. The program portion is used for carrying program content while the non-program portion is used for carrying extra information or data such as the vertical and horizontal traces information. In the television broadcast standard, the non-program portion of the AV signal is typically the vertical blanking interval (VBI) found in each frame of the AV signal.

More recently, a variety of digital video broadcast (DVB) standards are also used for broadcasting programs via satellite (DVB-S), cable (DVB-C), terrestrial (DVB-T), or via handheld and mobile terminals (DVB-H). Similar to the VBI in the analog AV signals, DVB broadcast signals also allow the simulcasting of supplementary content or data through DVB-TXT or DVB-VBI. When a digital broadcasting system is employed, the DVB-TXT/VBI is used to deliver the supplementary content as described in the foregoing. For convenience, the description “vertical blanking interval” refers to the vertical blanking interval (VBI) of the analog broadcast television signal, as well as the equivalent non-program portion of the digital broadcast television signals.

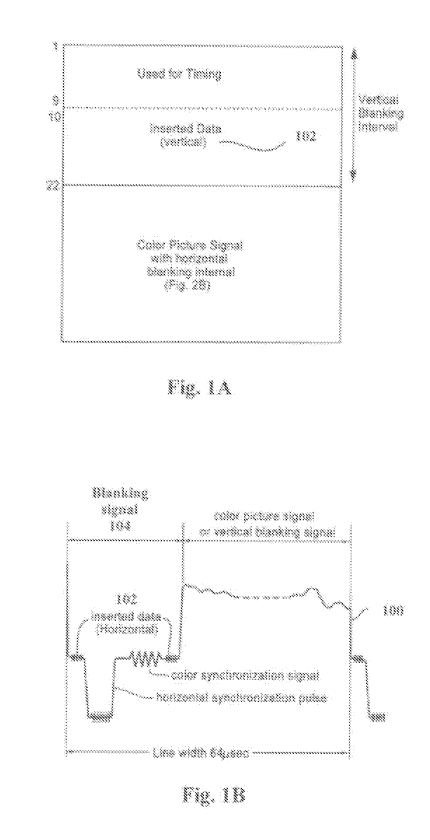

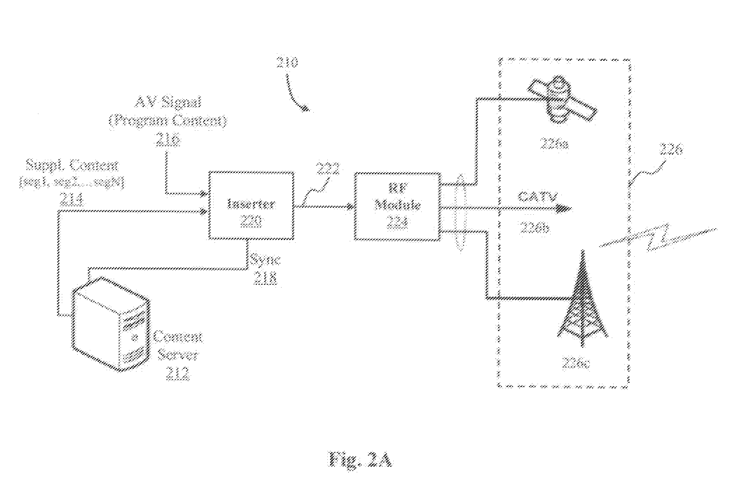

FIG. 1A illustrates the location of VBI in a conventional television broadcast signal employed in the embodiments. A standard television signal consists of 625 horizontal lines (575 in North America) divided into two frames of 312.5 lines each. The VBI makes up the first 21 lines of each frame. Lines 1 to 9 are typically used for timing setup and lines 10 to 21 are available for carrying data 102.

Each VBI line is capable of transmitting 288 bits per television frame (one packet). At 50 frames per second, 12 VBI lines per frame translate into a raw data rate transmission of about 144 Kbits per second. However, ensuring data integrity requires forward error correction and this reduces the throughput to about 70 Kbits per second. This throughput is better than those provided by asynchronous telephone lines which have a throughput of 19.2 Kbits per second. The error rate after error correction is 1.0e-5 and this compares favorably with telephone network based data transmission technologies.

FIG. 1B illustrates the location of horizontal blanking interval (HBI) in an analog television AV signal 100 which may also be employed in the embodiments instead of the VBI. Data 102 which is inserted into the horizontal blanking portion 104 is not displayed on the television screen along with the program content, as the television tuner is operable to process only the program content embedded in the other portions of the television AV signal 100. Accordingly, references made to VBI herein also extend to HBI.

In a teletext system, a separate channel of information is formed by inserting various types of information, such as news, sports, advertisements, and so on, in the VBI of the television AV signal 100. Typically, the various types of information do not have any correlation with the particular program content of the television AV signal 100. In an embodiment, the VBI is utilized to transport supplementary content specific to the program content of the particular television AV signal 100. In a further embodiment, the supplementary content inserted in a particular VBI represents a supplementary content associating with the program content embedded in adjacent program portions of the AV signal. In this way, each program segment may have a different supplementary content associated therewith and the supplementary content can be accessed substantially concurrently with the rendering of the segment of the program content at the conventional television set.

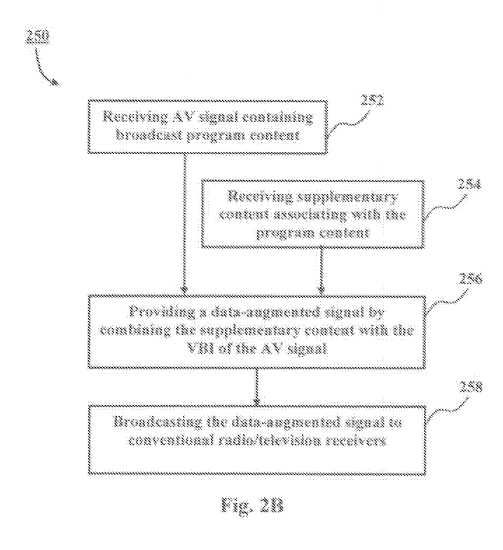

An embodiment of a system 210 and corresponding method 250 for providing data-augmented AV signals are respectively illustrated in FIGS. 2A and 2B. Referring first to the system 210 illustrated in FIG. 2A, the system 210 includes a content server 212, an inserter 220, an RF module 224, and a transmitter 226, which may include a satellite transmitter 226a, a cable television transmitter 226b, or a transmitting tower 226c. These transmitting means are only exemplary, and other transmitter embodiments will be apparent to those skilled in the art.

The content server 212 is operable to provide supplementary content 214 which is associated solely with a program content conveyed in an AV signal 216 provided to the inserter 220. The supplementary content 214 may further include information concerning the program content, such as additional facts, figures or other data, contact information such as a telephone number, physical or email addresses, and the like information which is specific to the program content of the a particular broadcast program. Further, identifying information such as the version number, size, copyright/digital-right status, author and language of the supplementary content file may be included. Additionally, program-specific advertiser or sponsor information may be included in the supplementary content 214. For example, information such as a list of manufacturers who provide cooking equipment shown in a cooking program.

In another embodiment, the supplementary content 214 may include interactive information which is designed to create an interactive session with the television viewers. Such information may include viewer queries which poses questions regarding the content of the broadcast program, and which invites a response thereto. Those skilled in the art will appreciate that other types of supplementary content may be included.

The supplementary content 214 may be parsed into two or more segments with each segment corresponding to a different segment of the program content as conveyed in the AV signal 216. For example, a cooking show may describe the processes of preparing several different dishes. The supplementary content 214 may accordingly include different content segments which include details regarding recipes, recommended cooking times, and so on for the different dishes. The content segments are accordingly sequenced so that the supplementary content conveyed therein is synchronized with the corresponding segments of the program content received by the inserter 220. This process may be facilitated by the use of a synchronization signal 218 communicating between the content server 212 and the inserter 220.

In an embodiment, the supplementary content 214 is organized into a structured file or document, such as an extensible markup language (XML) document. As such, the supplementary content 214 may includes meta-data which is tagged using known or broadcast industry adopted tags and fields. For example, identification of an advertiser or sponsor associated with one or more segments of the supplementary content may be identified using a meta-data tag “Sponsor ID”. Other meta-data tags corresponding to additional information may also be used. For example, meta-data tag “Lang ID” may be used to identify the language of the supplementary content, “Date ID” to identify the composition date of the supplementary content, “DRM ID” to identify digital rights management information, “Exp ID” to identify an expiration date of the supplementary content, and “Enc ID” to identify encryption information applied to the supplementary content. The aforesaid tags represent only a small sample of the possible meta-data tags and types of information which can be conveyed, and other meta-data tags may be used alternatively to or in addition thereto in other embodiments.

Furthermore, the structured document may be linked (i.e., associated) with the program, either as one complete document which contains one or more segments of the supplementary content, or as a document having only a single segment of the supplementary content. In the latter case, two or more such documents are used to compose the entire stream of supplementary content 214 with each document being linked to a corresponding segment of the program content. The supplementary content 214, in this exemplary embodiment, includes both the supplementary content associating with the program content and identifying information (e.g., “Sponsor ID”) in XML meta-data file.

The inserter 220 adds application level forward error correction (FEC) to the supplementary content 214 and thereafter embeds the treated supplementary content 214 in the non-program portion (i.e. VBI in the case of a television AV signal) of the AV signal 216. The output from the inserter 220 is a data-augmented AV signal 222 which is fed to the RF module 224. The RF module 224 channel codes the data-augmented AV signal 222 before converting it to an intermediate frequency and finally to an RF broadcast signal for broadcasting. The RF broadcast signal is broadcast using the transmitter 226 via one of the transmitting means described in the foregoing.

In DVB standards, the data-augmented AV signal 222 is broadcast in MPEG2 and the like digital formats. Thus, an encoder (not shown) is provided to converted the data-augmented AV signal 222 output from the inserter 220 into an MPEG2 stream before feeding the MPEG2 stream to the RF module 224 for further signal conditioning.

Referring to FIG. 2B in which the corresponding method 250 of providing the data-augmented AV signal is illustrated. Initially at step 252, the inserter 220 receives streams of AV signal (containing a program content) 216 of a broadcast program. In one embodiment, the program content typically includes ready produced audio/video of the broadcast program and is provided along with supplementary content identifying information, sponsor/advertiser information, or other program related contents. In another embodiment, however, such as live televised sports programs, the program content is produced in real-time. Thus, the corresponding supplementary content 214 (for example, the batting average of a currently displayed baseball player at-bat which may be prepared beforehand and stored in the content server 212), is supplied to the inserter 220 synchronously with the live program content.

In step 254, the inserter 220 receives the supplementary content 214 associating with the program content from the content server 212. Subsequently in step 256 (also referring to FIG. 2A), the supplementary content 214 is combined with or inserted in the VBI of the AV signal 216 to provide the data-augmented AV signal 222. Additional processes may be used to complement the combining processes at the inserter 220. For example, a forward error correcting algorithm may be applied to the supplementary content 214 to improve transmission reliability. Of course, other coding algorithms may be used in alternative embodiments.

In an embodiment, the provision of the supplementary content 214 can be synchronized with the appropriate program content segment using the synchronization signal 218. Thus, the combining process involves synchronizing segments of the supplementary content 214 with the vertical blanking intervals of the AV signal 216 portions which carry the corresponding segments of the program content. The data-augmented AV signal 222 retains the signal waveform of the original television AV signal 216 and can therefore be processed by a television set in the conventional manner. In step 258 (also referring to FIG. 2A), the data-augmented AV signal 222 is provided to the RF module 224 for channel coding and modulation with a carrier signal to provide an RF broadcast signal. Subsequently, the RF broadcast signal is broadcast to receivers using the transmitter 226.

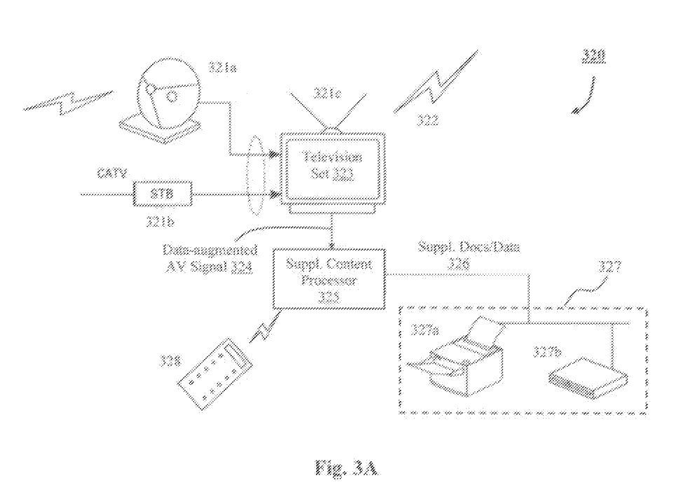

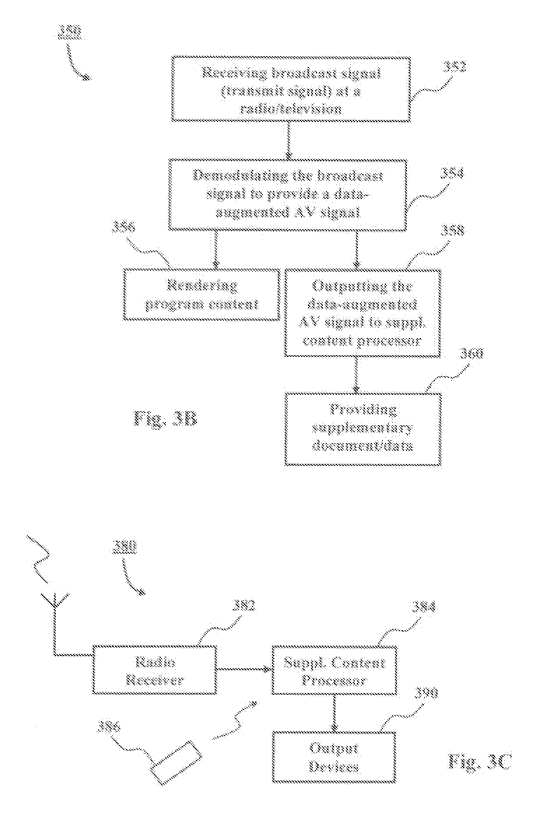

An embodiment of a system 320 and corresponding method 350 for processing data-augmented AV signals are respectively illustrated in FIGS. 3A and 3B. Referring first to the system 320 illustrated in FIG. 3A, the system 320 includes a receiving means 321 (a, b, c), a conventional television set 323, a supplementary content processor 325, a content output means 327 (a,b), and optionally, a remote controller unit 328. Exemplary receiving means includes a satellite receiver 321a, a set top box 321b, and a television aerial 321c, each of which is adapted to receive RF broadcast signal 322 which can be processed by the convention television set 323 in the conventional manner. The television set 323 has electronic circuits to perform the reverse processes that take place at the broadcasting end. The television set 323 demodulates the RF broadcast signal 322 to provide a data-augmented AV signal (i.e. base-band signal) 324 which contains the program content and the supplementary content.

The conventional television set 323 then renders the program content on the television screen in the conventional manner. At the same time, the data-augmented AV signal 324 is output to the supplementary content processor 325, for example, via a video output port of the conventional television set 323, where the supplementary content is extracted therefrom.

The supplementary content processor 325 further processes the extracted supplementary content to provide supplementary documents or data 326 which are associated with the program content being rendered on the conventional television set 323. Subsequently, the supplementary data 326 can be output to a printer 327a for hardcopy printout or can be stored in a data storage device 327b.

In an embodiment, the remote controller unit 328 (the functionality of which may be incorporated into a remote control of the conventional television set 323) can be used to control the supplementary data downloading process at the supplementary content processor 325. In an embodiment, the remote controller unit 328 is operable to instruct the supplementary content processor 325 to process the data-augmented AV signal 324 whereby the supplementary content 324 corresponding to the currently viewed program content is extracted and assembled to provide the supplementary documents or data 326 which are subsequently delivered to one or more of the output devices 327. In this manner, the viewer can download supplementary content concurrently with little or no disruption to the program viewing experience.

FIG. 3B illustrates a method 350 of processing a data-augmented AV signal using the system 320 of FIG. 3A. Initially at step 352, the RF broadcast signal 322 is received (or recovered by the receiving means 321). The RF broadcast signal 322 is in the format of an original television broadcast signal which can be processed by the conventional television set 323 in the conventional manner. The RF broadcast signal 322 contains the data-augmented AV signal. In step 354, a demodulating circuit (not shown) of the television set 323 is used to demodulate the RF broadcast signal 322 (in the conventional manner) to provide a base-band signal (i.e. the data-augmented AV signal 324) which contains the program content and the supplementary content. The program content is subsequently rendered on the television screen in the conventional manner in step 356. At substantially the same time, the data-augmented AV signal 324 can be output to the supplementary content processor 325 for extracting and processing the supplementary content in step 358.

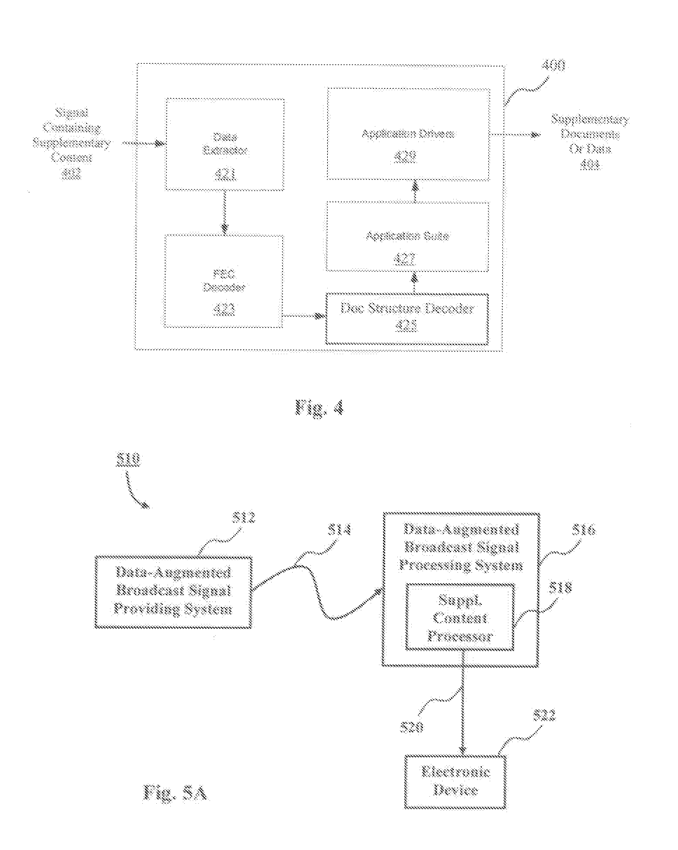

The supplementary content processor 325 is operable to extract the supplementary content from the data-augmented AV signal and assembles the supplementary content into one or more printable supplement documents or data 326. Further details of the supplementary content processor 325 are described below with reference to FIG. 4. The supplementary documents or data 326 are delivered to output devices 327, which in two exemplary embodiments include a printer 327a and a data storage device 327b in step 360. It should be noted that other output devices may be used alternatively or in addition thereto. Connection between the supplementary content processor 325 and the output devices 327 may be realized through various connection means, such as USB, IEE1394, SCSI, parallel connections, wireless connections (e.g. Bluetooth, WiFi), and the like communication means.

Radio Data-Augmented Signal

The system 210 and method 250 of FIGS. 2A and 2B can also be used to provide and process radio signals augmented with data. As an example, a digital audio broadcasting (DAB) system employs a non-program audio signal component, commonly known as a program associated data (PAD) channel, which can be used as the vehicle for transporting the supplementary content. In such an embodiment, the system 210 and corresponding method 250 can be used in substantially the same manner, as described in the foregoing, for receiving and processing a DAB broadcast signal of a DAB program and supplementary content associating with the DAB program. The supplementary content is provided by the content server 212. The inserter 220 which is adapted for processing the DAB broadcast signals is used to insert the supplementary content into the PAD channel of the DAB signal, thereby forming a (DAB) radio data-augmented signal. The specific modulation process is a known art and is governed by the DAB broadcasting standards. The radio data-augmented signal can then be transmitted via the conventional means, exemplary embodiments which may include satellite, cable or tower transmitters.

Likewise, similar system and method to those of FIGS. 3A and 3B may be used for receiving and processing the radio data-augmented signal. In an exemplary embodiment, a radio system 380 for receiving and processing a radio broadcast signal of the aforementioned DAB is shown in FIG. 3C. The radio system 380 includes a conventional radio receiver 382 for receiving the radio broadcast signal. Additionally, the conventional radio receiver 382 includes a demodulator or other such circuitries operable to demodulate the radio broadcast signal to provide a radio base-band signal (i.e. the radio data-augmented signal) containing the DAB program and supplementary content. The radio system 380 further includes a supplementary content processor 384 for receiving the base-band signal and extracting the supplementary content therefrom. The supplementary content is then assembled to provide one or more supplement documents or data, which, for instance, by using a remote controller unit 386, can be delivered to an output device 390. The output device 390 can be a printer, data storage device, PDA, PC, and the like electronic devices.

FIG. 4 illustrates a functional block diagram of a supplementary content processor 400 (such as the supplementary content processor 325 shown in FIG. 3A) that includes a data extractor 421, an optional forward error correction (FEC) decoder 423, a document structure decoder 425, an application suite 427, and associated application drivers 429. During operation, streams of base-band signal 402 containing the supplementary content is supplied to the supplementary content processor 400. The data extractor 421 extracts embedded supplementary content, for examples applets or programming, from the base-band signal 402. Additional operations within the data extractor 421 may include parsing the supplementary content into segments, if this format is needed or the recovered supplementary content is not so arranged.

Once the supplementary content is extracted from the base-band signal 402, the supplementary content is put through the FEC decoder 423 to correct any errors introduced during broadcasting. The output from the FEC decoder 423 is subsequently fed to the document structure decoder 425.

In an embodiment, the supplementary content (which may include more than one segment, as described above) is recovered in the form of structured data such as XML-formatted data. In such an embodiment, the document structure decoder 425 is employed to decode the meta-data, or other such similar data used in alternative structured document. The decoded data is supplied to the application suite 427 which further assembles the decoded data into the desired format (i.e. data 404) for a particular application. The application drivers 429 are operable to interface with a particular output device 327, and may be incorporated within the application suite 427 in an alternative embodiment. The appropriately formatted data 404, referred to in the foregoing FIG. 3A as supplementary documents or data 326, is subsequently provided to one or more of the output devices 327.

The supplementary content processor 400 may further include a remote controller interface module (not shown) to which various command signals can be issued for instructing the supplementary content processor 400 to perform one, some, or all of the aforementioned supplementary content processor functions. As an example, the supplementary content processor 400 continually processes streams of supplementary content segments as described in relation to the content server 212 of FIG. 2A. Each supplementary content segment includes supplementary content corresponding to, and synchronized with, a segment of the program content. When the viewer is presented with a topic that the viewer desires to acquire more information on, the viewer actuates the appropriate buttons on the remote controller unit. The signal produced thereby in turn activates the supplementary content processor 400 to generate the supplementary document or data 404 for output to one or more of the output devices. In this manner, the corresponding content segment can be downloaded (as a printed or stored electronic document, for instance) conveniently with minimal disturbance to the viewing experience.

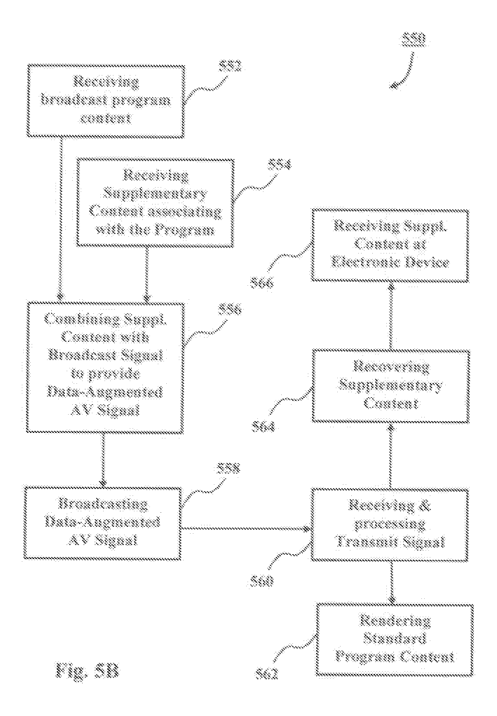

In many broadcasting situations, whether radio or television, audience members may want to obtain extra information relating to the radio or television program being broadcast. In an embodiment, the systems and methods described in the foregoing can be used for delivering the extra information (i.e. contents) to electronic devices of the audience members as described hereinafter with reference to FIGS. 5A and 5B. FIGS. 5A and 5B respectively illustrate a system 510 and method 550 for delivering contents to electronic devices using broadcast networks.

The system 510 as shown in FIG. 5A includes a data-augmented broadcast signal providing system 512, a data-augmented broadcast signal processing system 516, and an electronic device 522. In this exemplary embodiment, the data-augmented broadcast signal providing system 512 and the data-augmented broadcast signal processing system 516 are similar in makeup to the respective systems shown in FIGS. 2A and 3A (and 3C) as described in the foregoing. Information or data associating with a broadcast program is provided as a supplementary content to the data-augmented broadcast signal providing system 512. The supplementary content are combined with the broadcast program to provide a data-augmented AV signal which is subsequently modulated with a carrier signal to provide a transmit signal 514 for broadcasting in the conventional manner (i.e. television or radio broadcasting). At the receiving end, the transmit signal 514 is received by the data-augmented broadcast signal processing system 516. The data-augmented broadcast signal processing system 516 demodulates the transmit signal 514 to provide a base-band signal (i.e. The data-augmented AV signal) containing the program content and the supplementary content. The base-band signal is output to a supplementary content processor 518 where the supplementary content is extracted and further processed.

Subsequently, the supplementary content processor 518 may, upon the audience issuing a command by using a remote controller (such as the one shown in FIG. 3A), delivers the supplementary documents or data to the electronic device 522 via a link 520. The electronic device 522 can be an SMS, WAP or GPRS or the like enabled mobile phone, PDA, or a PC. Accordingly, the link 520 (communication means) can be a wireless connection such as Bluetooth, WiFi, and infra-red, or wired connection such as USB, Firewire, serial, or parallel connections. The electronic device 522 is registered with the supplementary content processor 518 in order to receive the data. However, not all electronic devices registered with the supplementary content processor 518 need to receive the data every time a requesting instruction is issued. The supplementary content processor 518 can be provided with a user option to select which of the electronic devices registered therewith should receive the data and only sends the data to the electronic devices specified therein. The user option can be presented on the display of the receiver (e.g. television screen) or a display of the supplementary content processor 518. Further, the supplementary content processor 518 can be provided with an application that includes an application logic to determine which of the registered electronic devices should be forwarded which kind of data. The application logic can encompass forwarding all data to all registered devices to only sending data based on user preference or prior user requests.

The method 550 of delivering contents to an electronic device using broadcast networks as shown in FIG. 5B includes receiving an AV signal of a broadcast program in step 552. The program can be a television or radio broadcast relating to movies, news, sports, current affairs, and so on. In step 554, supplementary content or extra information associating with the broadcast program content is received. The supplementary content can be any information associating with the broadcast program which the audience members may be interested in. The supplementary content is combined with the non-program portion (e.g. VBI) of the AV signal to provide a data-augmented AV signal in step 556. The data-augmented AV signal has the same format as the original AV signal. Thus, the data-augmented AV signal can be treated, broadcast and received in the same manner as a conventional television or radio broadcast signal. The data-augmented AV signal is subsequently modulated with a carrier (broadcast) signal to provide a transmit signal for broadcasting to conventional receivers in step 558.

In an embodiment, in step 556, the supplementary content is combined with a specific non-program portion segment of the AV signal to coincide with the specific program-portion segment of the program content. For example, if a supplementary content is closely related to a segment of the program content, the supplementary content is combined with the non-program portion adjacent to the program portion of the related segment of the program content of the AV signal. In this way, at the receiver end, the audience is presented with the option to download the supplementary content at the appropriate time when the audience is most influenced by the program content segment.

In step 560, the transmit signal is received by a conventional receiver. The conventional receiver processes the transmit signal in the conventional manner. Typically, step 560 includes demodulating the transmit signal to provide a base-band signal (i.e. the data-augmented AV signal) which contains the program content and the supplementary content. In the case where the transmit signal is a radio signal, the conventional receiver is a radio receiver and it retrieves the program content from the base-band signal and presents the program content to the listener in audio form. In the case where the transmit signal is a television signal, the conventional receiver is a television receiver and it renders the program content on the television screen. The act of rendering the program content is performed in step 562, a process well known in the art.

At substantially the same time of rendering the program content, the base-band signal is output to a supplementary content processor in step 564. The supplementary content processor, as described in the foregoing with reference to FIGS. 3A and 4, recovers the supplementary content from the base-band signal, processes the supplementary content before delivers it to an electronic device. The act of delivering the supplementary content to the electronic device can be accomplished in any number of known ways. This includes sending the supplementary content electronically to the electronic device via a wireless connection or a wired connection. The electronic device can be a mobile phone, PDA, or a PC. In step 566, the supplementary content is received at the electronic device where the supplementary content is either stored or presented to the user depending on the nature of the supplementary content.

For example, in an embodiment, while watching a movie on a television at home, an audience member desires to obtain the theme song of the movie for use as a ring-tone on his mobile phone, a trailer of the movie for showing to a friend, and a picture for use as a wall-paper or screen saver on his mobile phone. The audience member can conveniently obtain the desired supplementary contents by instructing the supplementary content processor to display the possible supplementary content available either on a display of the supplementary content processor or on the television screen (e.g. superimpose with the program content being rendered thereon). In an embodiment, during the rendering of the program content, an indicator may be shown on the display of the supplementary content processor or on a portion of the television screen to indicate the availability of the supplementary contents. Thereafter, the audience member may select the desired supplementary contents by using, for example, a remote controller unit. Upon receiving the request, the desired supplementary content is delivered to the mobile phone (registered with the supplementary content processor) of the audience member. In an alternative embodiment, the registered mobile phone can be adapted to allow the user to directly issue a request for supplementary contents to the supplementary content processor.

Each type of supplementary contents includes a metadata for differentiating one type from another and for indicating the electronic devices the supplementary content is suitable for. In this exemplary embodiment, each of the theme song, the trailer, and the picture includes a metadata which describes the name of the content, data format (e.g. binary, ASCII, etc), size, and type of content. Further, for example, if the content is provided in the XML format (other formats can also be used), a mobile phone application can be included which can be transferred to the mobile phone for installation and operation thereon. Thus, upon receiving the supplementary contents at the mobile phone, the mobile phone knows how to manage the supplementary contents and launches the appropriate applications.

The metadata can also include digital rights management (DRM) information for intellectual property rights control. Each audience member can be provided with an access key to unlock the contents. The access key is obtainable by subscribing to a subscription package from a broadcast company or content provider. To unlock the contents, the audience member may be prompted to enter the access key (e.g. by using the buttons on the remote controller unit) upon selecting each desired supplementary content. It should be noted that other forms of securities (e.g. biometric) can also be employed. These various forms of securities are well known in the art.

As readily appreciated by those skilled in the art, the described processes may be implemented in hardware, software, firmware or a combination of these implementations as appropriate. For example, the processes of combining, modulating, and broadcasting signals may be carried out by hardware component modulators and transmitter systems operable to modulate and broadcast signals at the desired frequency and in the desired format. The described supplementary content processor may employ a combination of hardware front-end receiver components operable to additionally demodulate and/or condition the received supplementary content, and firmware/software operable to FEC decode the supplementary content and to store/process the resultant data as well as the output applications and device drivers. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

The foregoing description is presented for purposes of illustration and description. It is not intended to be exhaustive or to limit the invention to the precise form disclosed, and obviously many modifications and variations are possible in light of the foregoing description. The described embodiments are chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method comprising:
receiving a transmit signal at a receiver, the transmit signal having a program content and supplementary content associating therewith;
demodulating the transmit signal to provide a data-augmented signal;
rendering the program content;
recovering the supplementary content from the data-augmented signal at substantially the same time the program content is rendered; and
delivering the supplementary content to an electronic device.

2. The method of claim 1, wherein recovering the supplementary content comprises:
outputting the data-augmented signal to a processor; and
extracting the supplementary content from the data-augmented signal at the processor, the supplementary content having a metadata containing information including at least one of a name, data type, data size, content type, and digital rights management information of the supplementary content.

3. The method of claim 2 further comprising providing an indicator on a display of the receiver or the processor, the indicator indicating the availability of the supplementary content.

4. The method of claim 2, wherein delivering the supplementary content to the electronic device comprises:
verifying the electronic device is registered with the processor; and
delivering the supplementary content to the electronic device using communication means including at least one of a Bluetooth, WiFi, infra-red, USB, firewire, serial, and parallel connection.

5. The method of claim 4 further comprising delivering the supplementary content to the electronic device in response to receiving a request instruction at the processor.

6. The method of claim 4 further comprising delivering the supplementary content to the electronic device in response to receiving a correct access key at the processor.

7. The method of claim 5 further comprising using a remote controller unit for issuing the request instruction to the processor.

8. The method of claim 5 further comprising using the electronic device for issuing the request instruction to the processor.

9. The method of claim 1, wherein the supplementary content comprises at least one of a ring-tone, game, music, video clip, image, and text data.

10. The method of claim 1, further comprising:
combining the supplementary content with a program signal of the program content to provide the data-augmented signal, wherein the supplementary content is inserted into a non-program portion of the program signal; and
modulating the data-augmented signal with a carrier signal to provide the transmit signal for broadcasting.

11. The method of claim 10, wherein the program signal comprises a television broadcast signal having a vertical or horizontal blanking interval for use as the non-program portion.

12. The method of claim 10, wherein the program signal comprises a digital audio broadcasting signal having a program associated data channel for use as the non-program portion.

13. The method of claim 10, wherein combining the supplementary content comprises inserting the supplementary content into the non-program portion corresponding with the program portion of a specific segment of the program content to which the supplementary content is related.

14. A system comprising:
a receiver for receiving a transmit signal and demodulating the same to provide a data-augmented signal, the transmit signal having a program content and supplementary content relating thereto;
a processor coupled to the receiver for receiving the data-augmented signal and recovering the supplementary content therefrom; and
an electronic device registered with the processor for receiving the supplementary content substantially concurrently with the rendering of the program content at the receiver.

15. The system of claim 14, wherein the receiver comprises a television receiver operable to process at least one of NTSC, PAL, SECAM, and HDTV television broadcast signal.

16. The system of claim 14, wherein the receiver comprises a DAB radio receiver.

17. The system of claim 14, wherein the processor comprises communication means for delivering the supplementary content to the electronic device, the communication means comprises at least one of a Bluetooth, WiFi, infra-red, USB, firewire, serial, and parallel connection.

18. The system of claim 14, wherein the electronic device comprises at least one of a mobile phone, PDA, and a PC.

19. The system of claim 14, wherein the supplementary content comprises at least one of a ring-tone, games, music, video clip, image, and text data.

20. The system of claim 14 further comprising a remote controller for controlling the operation of the processor.

21. The system of claim 14 further comprising:
an inserter for combining the supplementary content with a program signal of the program content to provide the data-augmented signal; and
a modulator for modulating the data-augmented signal with a carrier signal to provide the transmit signal for broadcasting.

22. The system of claim 21 further comprising a content server for storing and providing the supplementary content to the inserter.

23. The system of claim 22, wherein the content server comprises a synchronizing signal with the inserter for coordinating the combining process.
